(19) United States
(12) Patent Application Publication
(10) Pub. No.: US 2021/0008886 A1
(43) Pub. Date: Jan. 14, 2021

(54) ENCAPSULATING LAYER FOR PRINTHEAD ASSEMBLIES

(71) Applicant: HEWLETT-PACKARD DEVELOPMENT COMPANY, L.P., Spring, TX (US)

(72) Inventors: Huy Le, Corvallis, OR (US); Theodore W. Lamb, Vancouver, WA (US); James M. Brenner, Vancouver, WA (US); Stephen A. Conner, Corvallis, OR (US)

(21) Appl. No.: 16/604,153

(22) PCT Filed: Jan. 22, 2018
(86) PCT No.: PCT/US2018/014664

§ 371 Date: Oct. 9, 2019

(51) Int. Cl. B41J 2/165; B41J 2/14

(52) U.S. Cl. CPC B41J 2/16505; B41J 2/16585; B41J 2/14

(57) ABSTRACT

The present disclosure is drawn to printhead assemblies including an encapsulating layer. For example, a printhead assembly can include a first printhead including a first array of dispensing nozzles and a second printhead including a second array of dispensing nozzles. The first and second array of dispensing nozzles can be positioned along an ejection surface of the printhead assembly. A removable cured encapsulating layer can be molded to conform to the ejection surface and fluidly seal the first array and

### BACKGROUND

Inkjet printers can include a wide variety of inkjet printheads or printhead assemblies. For example, some inkjet printers, such as HP PageWide® web press printers from HP, Inc., include a media width arrangement of stationary printhead assemblies that can be used to print on paper or other print media moving past the arrangement or assembly of printheads. In other examples, a printhead assembly can move relative to the print media to print thereon.

### BRIEF DESCRIPTION OF THE DRAWINGS

Additional features of the disclosure will be apparent from the detailed description which follows, taken in conjunction with the accompanying drawings, which together illustrate, by way of example, features of the present technology.

FIG. 1 illustrates a plan view of an ejection surface of an example printhead in accordance with the present disclosure.

FIG. 2A illustrates a plan view of an ejection surface of an example printhead assembly in accordance with the present disclosure.

FIG. 2B illustrates a side cross-sectional view of the example printhead assembly of FIG. 2A.

FIG. 3 illustrates a plan view of an alternative ejection surface an example printhead assembly in accordance with the present disclosure.

FIG. 4 illustrates an example printer in accordance with examples of the present disclosure.

FIG. 5 illustrates flow chart of an example method of fluidly sealing dispensing nozzles of a printhead assembly in accordance with the present disclosure.

Reference will now be made to several examples that are illustrated herein, and specific language will be used herein to describe the same. It will nevertheless be understood that no limitation of the scope of the disclosure is thereby intended.

### DETAILED DESCRIPTION

Some inkjet printers, such as HP PageWide® web press printers from HP, Inc., can include an approximately media width arrangement of stationary printhead assemblies, a page-wide printer bar with an array of nozzles, or the like that can be used to print on paper or other print media moving past the arrangement or assembly of the stationary printheads. In other examples, a printhead or an assembly, such as with multiple printheads, can be configured to move relative to the print media to deposit an ink, or other printing fluid, thereon. In either case, when a printhead or printhead assembly is preloaded with a printing fluid prior to shipment, printing fluid from one dispensing nozzle can leak into another dispensing nozzle causing an undesirable combination of printing fluids, or the printing fluids can become dried out. Even marginal drying can be undesirable with some types of printing fluids. In some cases, this can be mitigated by the use of a mechanical shipping cap. However, a mechanical shipping cap may have inadequate conformity to the ejection surface, including the dispensing nozzles, and may not provide an adequate fluid seal. As such, even with a mechanical shipping cap, some printing fluid mixing or drying can occur and some of the dispensing nozzles can become blocked due to air infiltration. Thus, in some cases, it can be desirable to ship the printhead or printhead assembly with a shipping and handling (S&H) fluid instead of a printing fluid to prevent undesirable mixing of printing fluids in the printhead or printhead assembly and/or blockage of dispensing nozzles with air. However, use of an S&H fluid can also prolong initialization procedures to get the printhead or printhead assembly primed with printing fluid and ready to perform. Further, in some cases, residual S&H fluid can cause some print jobs following initialization to have somewhat of a lower print quality.

Accordingly, the present disclosure describes printhead assemblies, which can include carriage printheads or a stationary print bar, for example, that can overcome some of these challenges, and in some instances, can allow the printhead assemblies to be shipped with printing fluid compositions contained even within the printhead nozzles of the of the printhead or printhead assembly. It is noted that, for the sake of convenience and brevity, general reference is made herein to printhead assemblies. It is also to be understood that such references can also refer to individual structures with multiple printhead regions, such as stationary page-wide printheads having arrays of dispensing nozzles, carriage printheads having an arrays of dispensing nozzles, or the like. With this in mind, a (single) printhead assembly can include a first printhead including a first array of dispensing nozzles and a second printhead including a second array of dispensing nozzles. The first array of dispensing nozzles and the second array of dispensing nozzles can be positioned along an ejection surface of the printhead assembly. A removable cured encapsulating layer can be molded to conform to the ejection surface and fluidly seal the first array and the second array of dispensing nozzles. In some examples, the printhead assembly can also include a first printing fluid in fluid communication with the first array of dispensing nozzles and a second printing fluid in fluid communication with the second array of dispensing nozzles. The first printing fluid and the second printing fluid can be fluidly sealed behind the removable cured encapsulating layer. In other examples, the removable cured encapsulating layer can be a UV cured polymeric layer. In further detail, the removable cured encapsulating layer can be cohesive and have an adhesive strength suitable to allow for peeling from the ejection surface, as well as the first and second array of dispensing nozzles, as a single piece. In yet other examples, the printhead assembly can be a page wide printhead assembly, such as a printer bar, and can include from three to fourteen printheads (each with an array of nozzles) individually associated with a respective array of dispensing nozzles. In still other examples, the removable cured encapsulating layer can include a support material associated therewith. In some cases, the support material can be a mesh material that is partially or fully encapsulated within a cured polymer of the removable cured encapsulating layer.

In some examples, the printhead assembly can also be included as part of a printer. The printhead assembly of the printer can include a first printhead including a first array of dispensing nozzles in fluid communication with a first storage fluid, wherein the first array of dispensing nozzles are positioned along an ejection surface of the printhead assembly. The printhead assembly can also include a second printhead including a second array of dispensing nozzles in fluid communication with a second storage fluid, wherein the second array of dispensing nozzles are also positioned along the ejection surface of the printhead assembly. A removable cured encapsulating layer can be molded to conform to the ejection surface and fluidly seal the first storage fluid within the first array of dispensing nozzles and the second storage fluid within second array of dispensing nozzles. In addition to the printhead assembly, the printer can also include a removal device controlled by the printer to peel or otherwise remove the removable cured encapsulating layer from the ejection surface, the first array of dispensing nozzles, and the second array of dispensing nozzles. In some further examples, the printer can include a print media feeder to position and feed print media to a print area operably associated with the first printhead and the second printhead. In some examples, the first storage fluid can be a first printing fluid and the second storage fluid can be a second printing fluid.

Methods of fluidly sealing dispensing nozzles of a printhead assembly are also described herein. In some examples, the methods can include applying a viscous sealing fluid to an ejection surface of the printhead assembly. The printhead assembly can include a first array of dispensing nozzles of a first printhead and a second array of dispensing nozzles of a second printhead. The viscous fluid can conform to the ejection surface over the first array of dispensing nozzles and the second array of dispensing nozzles. The viscous sealing fluid can be cured to form a removable cured encapsulating layer that is solidified and molded to conform to the printing surface and fluidly seal the first array of dispensing nozzles and the second array of dispensing nozzles. In some examples, the viscous sealing fluid can have a viscosity of from about 25,000 centipoise (cP) to about 150,000 cP. In other examples, curing can include UV curing. In still other examples, curing is performed within about 5 minutes from the time of application of the viscous sealing fluid, within about 2 minutes, within about 1 minute, within about 30 seconds, e.g., from about 5 seconds to about 5 minutes, about 15 seconds to about 5 minutes, about 30 seconds to about 5 minutes, about 1 minute to about 5 minutes, from about 5 seconds to about 2 minutes, from about 5 seconds to about 1 minute, from about 5 seconds to about 30 seconds, etc.

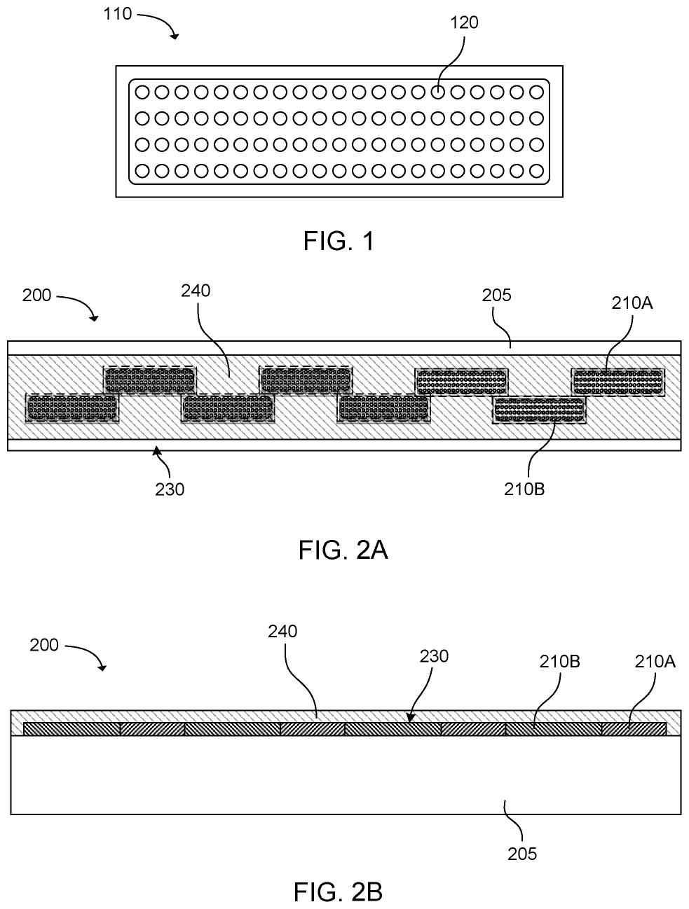

In further detail, a printhead assembly or print bar can include a first printhead and a second printhead. FIG. 1 illustrates one example of a printhead 110 or die that can be included in a printhead assembly. Individual printheads or dies can include an array of dispensing nozzles 120. It is noted that the printhead illustrated in FIG. 1 is not drawn to scale, but is merely illustrated to facilitate a general description of the printhead.

In some examples, the array of dispensing nozzles 120 of the printhead 110 can dispense a single printing fluid (e.g. black printing fluid, cyan printing fluid, magenta printing fluid, or yellow printing fluid, for example). In other examples, the array of dispensing nozzles can be organized into groups or slots, where individual groups or slots of the array can dispense separate printing fluids. In one specific example, as illustrated in FIG. 1, the array of dispensing nozzles can be organized into four rows of dispensing nozzles where individual rows can represent an individual group of dispensing nozzles. However, other grouping arrangements other than rows can also be employed, such as columns, groups of rows, groups of columns, other geometrical arrangements, etc. In some examples, individual groups of dispensing nozzles can dispense separate printing fluid varieties. Accordingly, in some examples, a printhead including four groups of dispensing nozzles can dispense four different printing fluid varieties (e.g. black, cyan, magenta, and yellow, for example). Individual groups of dispensing nozzles can include any suitable number of dispensing nozzles. In some examples, individual groups of dispensing nozzles can include tens, hundreds, or thousands of individual dispensing nozzles. Further, individual printheads of a printhead assembly can include any suitable number of groups of dispensing nozzles, such as one, two, three, four, five, six, etc. groups of dispensing nozzles.

A suitable number of individual printheads can be assembled together to prepare a printhead assembly. One example of a printhead assembly 200 is illustrated in FIGS. 2A and 2B. The printhead assembly can include a first printhead 210A and a second printhead 210B secured in a base or frame 205. The first printhead can include a first array of dispensing nozzles (See FIG. 1, for example) positioned along an ejection surface 230 of the printhead assembly. The second printhead can include a second array of dispensing nozzles (See FIG. 1, for example) positioned along the ejection surface of the printhead assembly. The first and second print head are shown in phantom lines as they would actually be positioned beneath the removable cured encapsulating layer 240 described herein below.

In some examples, the printhead assembly can be a page wide printhead assembly that includes an arrangement of multiple stationary printheads that can be used to print on paper or other print media moving past the arrangement or assembly of stationary printheads. In some examples, the printhead assembly can include from three printheads to twenty printheads. In some further examples, the printhead assembly can include from eight to sixteen printheads. In some specific examples, the printhead assembly can include 8, 10, 12, 14, or 16 printheads.

As noted above, in some cases, individual dispensing nozzles can leak during shipping and or storage of the printhead assembly. This can cause unwanted mixing of printing fluids. Additionally, air can infiltrate individual dispensing nozzles, which can cause air blockages of some dispensing nozzles. Both of these outcomes are undesirable and can be challenging to mitigate using a mechanical shipping cap. Thus, to further prevent unwanted mixing of printing fluids and air blockages of individual dispensing nozzles, the printhead assembly can include a removable cured encapsulating layer molded to conform to the ejection surface and fluidly seal the dispensing nozzles of individual printheads.

For example, as illustrated in FIGS. 2A and 2B, a removable cured encapsulating layer 240 can be molded to conform to the ejection surface 230 of the printhead assembly 200 and fluidly seal the first array of dispensing nozzles of the first printhead 210A and the second array of dispensing nozzles of the second printhead 210B. In some examples, the removable cured encapsulating layer can isolate or fluidly seal individual color groups or slots (e.g. black, cyan, magenta, yellow, for example) of an individual printhead from one another so as to prevent mixing of colors between color groups or slots, but perhaps not to prevent mixing within an individual color group or slot. Additionally, or alternatively, the removable cured encapsulating layer can fluidly seal individual dispensing nozzles so as to prevent mixing of colors between and within individual color groups or slots.

In some examples, the removable cured encapsulating layer can have properties that allow for peeling of the removable cured encapsulating layer from the ejection surface, and corresponding first and second array of dispersing nozzles, as a single piece without leaving remnants. This can be desirable for a number of reasons. For example, if a remnant of the removable encapsulating layer remains within a dispensing nozzle, the remnant can block the dispensing nozzle. Further, if the removable encapsulating layer breaks into several pieces or remnants during removal, the removal process can become overly cumbersome. Other undesirable outcomes can also result from a removable cured encapsulating layer that is not peelable as a single piece or a relatively small number of pieces.

There are a number of factors that can affect the ability to remove the removable cured encapsulating layer from the ejection surface of the printhead assembly. For example, in some cases, the removable cured encapsulating layer can have adequate cohesiveness to allow for peeling from the ejection surface, as well as the first and second array of dispensing nozzles, as a single piece. In some cases, adequate cohesiveness can be provided by curing the removable cured encapsulating layer, such as via thermal curing, electromagnetic curing, chemical curing, the like, or a combination thereof. In some specific examples, the removable cured encapsulating layer can be a UV cured polymeric layer. In some further examples, the removable cured encapsulating layer can have an adhesive strength that does not compromise the cohesiveness of the removable cured encapsulating layer during peeling. For example, where the removable cured encapsulating layer is sufficiently cohesive to peel as a single piece per se, but where the adhesive strength of the encapsulation layer to the ejection surface is excessively strong, the removable cured encapsulating layer can nonetheless break during peeling and leave remnants of the removable encapsulating layer on the ejection surface. Thus, the removable cured encapsulating layer can be cohesive and have an adhesive strength suitable to allow for peeling from the ejection surface, as well as the first and second array of dispensing nozzles, as a single piece.

In some further examples, the removable cured encapsulating layer can include a support material associated therewith to facilitate removal of the removable cured encapsulating layer as a single piece. For example, the support material can include an adhesive film, a backing material, a membrane, a loop, a string, a fabric, a mesh, the like, or a combination thereof that is adhered to the removable cured encapsulating layer, partially or fully encapsulated, entangled, or entrapped within a cured polymer of the removable cured encapsulating layer, the like, or a combination thereof. In some further examples, the support material can further include a mechanical interface to facilitate engagement of the support material by a removal tool or the like. Non-limiting examples of mechanical interfaces can include a loop, a hook, a keyhole, a net, a rod or pin, a magnet, a bracket, a brace, a slot or indentation, the like, or a combination thereof.

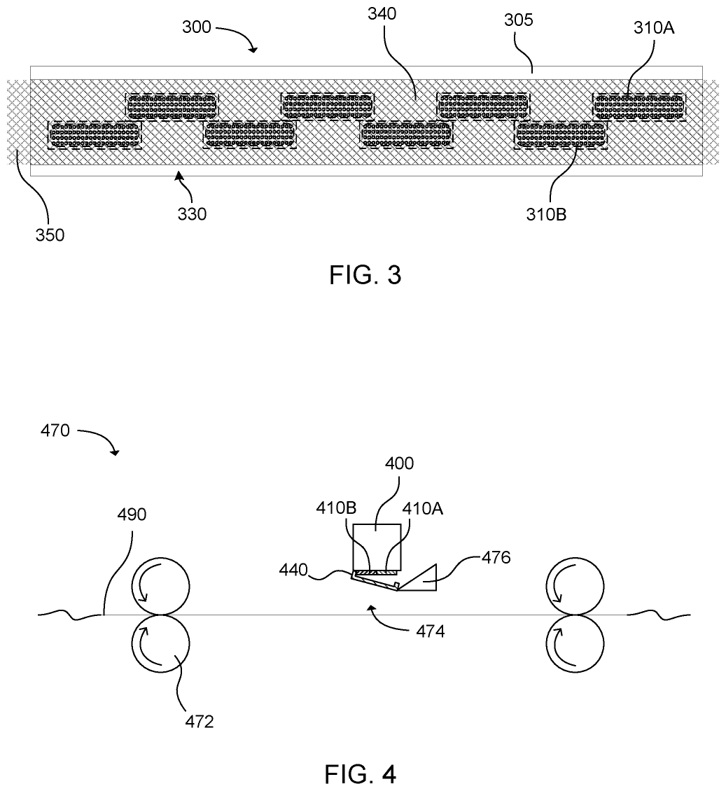

One non-limiting example of a printhead assembly having a support material associated therewith is depicted in FIG. 3. The printhead assembly 300 includes a first printhead 310A and a second printhead 3108 secured in a base or frame 305. The first printhead has a first array of dispensing nozzles (See FIG. 1, for example) positioned along an ejection surface 330 and the second printhead 3108 has a second array of dispensing nozzles (See FIG. 1, for example) positioned along the ejection surface. (The printheads are shown in phantom lines similar to that shown in FIG. 2A). The printhead assembly further includes a removable cured encapsulating layer 340 molded to conform to the ejection surface. A support material 350 is further associated with the removable cured encapsulating layer to facilitate removal of the removable cured encapsulating layer as a single piece. In this particular example, the support material can be a mesh material that has been associated with the removable cured encapsulating layer. The mesh material includes a number of loops or net-like structure that can act as a mechanical interface to facilitate attachment or engagement of a removal tool to help remove the removable cured encapsulating layer. While FIG. 3 illustrates the mesh extending from lateral ends of the perimeter of the removable cured encapsulating layer, this is not always the case. The mesh or other support material can extend from any suitable portion of the removable cured encapsulating layer for efficient removal of the layer efficiently and in many cases, as a single piece. Alternatively, in some examples, the support material does not extend beyond a perimeter of the removable cured encapsulating layer. Again, other types of support material can be used as described previously. For example, the support material may be attached to a surface of the polymer of the removable cured encapsulating layer, or the support material can be entrapped or contained fully or partially within the polymer of the removable cured encapsulating layer.

As described above, the removable cured encapsulating layer can be used to form a fluid seal with the first array of dispensing nozzles and the second array of dispensing nozzles. In some examples, the printhead assembly can include a first printing fluid or group of printing fluids in fluid communication with the first array of dispensing nozzles and a second printing fluid or group of printing fluids in fluid communication with the second array of dispensing nozzles. The first printing fluid or group of printing fluids and the second printing fluid or group of printing fluids can be sealed behind the removable cured encapsulating layer. In some examples, the first printing fluid or group of printing fluids can be the same as the second printing fluid or group of printing fluids. In some examples, the first printing fluid or group of printing fluids can be different from the second printing fluid or group of printing fluids. In other examples, the printhead assembly can include a first shipping and handling fluid in fluid communication with the first array of dispensing nozzles and a second shipping and handling fluid in fluid communication with the second array of dispensing nozzles. The first shipping and handling fluid and the second shipping and handling fluid can be sealed behind the removable cured encapsulating layer. In some examples, the first shipping and handling fluid can be the same as the second shipping and handling fluid. In other examples, the first shipping and handling fluid can be different from the second shipping and handling fluid.

The printhead assemblies described herein can also be included in a printer. In further detail, the printer can include a printhead assembly that includes a first printhead and a second printhead. The first printhead can include a first array of dispensing nozzles in fluid communication with first storage fluid, such as a first printing fluid or a first shipping and handling fluid. The first array of dispensing nozzles can be positioned along an ejection surface of the printhead assembly. The second printhead can include a second array of dispensing nozzles in fluid communication with a second storage fluid, such as a second printing fluid or a second shipping and handling fluid. The second array of dispensing nozzles can also be positioned along the ejection surface of the printhead assembly. A removable cured encapsulating layer can be molded to conform to the ejection surface and fluidly seal the first storage fluid within the first array of dispensing nozzles and the second fluid within the second array of dispensing nozzles. The printer can further include a removal device controlled by the printer to peel the removable cured encapsulating layer from the ejection surface, as well as the first array of dispensing nozzles and the second array of dispensing nozzles.

One example of a printer is illustrated in FIG. 4. The printer 470 can include a printhead assembly 400 having a first printhead 410A and a second printhead 4106. The first printhead can include a first array of dispensing nozzles (See FIG. 1, for example) in fluid communication with a first storage fluid. The second printhead can include a second array of dispensing nozzles (See FIG. 1, for example) in fluid communication with a second storage fluid. A removable cured encapsulating layer 440 can be molded to conform to an ejection surface and fluidly seal the first storage fluid within the first array of dispensing nozzles and the second storage fluid within the second array of dispensing nozzles. As noted above, the removable encapsulating layer can fluidly seal individual color groups from one another, individual dispensing nozzles from one another, or a combination thereof. The printer can further include a removal device 476 controlled by the printer to peel the removable cured encapsulating layer from the ejection surface, as well as the first array of dispensing nozzles and the second array of dispensing nozzles.

A variety of removal devices can be employed by the printer. Non-limiting examples can include a scrapper, a scrubber, a brush, a hook, a loop, a suction device, a claw, a clamp, a magnet, an actuator, the like, or a combination thereof. Generally, the removal device can include any device that is adequate to remove the removable cured encapsulating layer from the printhead assembly, such as is illustrated in FIG. 4.

Returning again to FIG. 4, in some examples, the printer can also include a print media feeder 472 to position and feed print media 490 to a print area 474 operably associated with the first printhead 410A and the second printhead 410B of the printhead assembly 400. In some examples, the printhead assembly can be stationary and the print media can be positioned relative to the printhead assembly during printing. In other examples, the printhead assembly can be mobile, such as via a carriage or the like, so as to position the printhead assembly relative to the print media as it is fed through the printer. In some specific examples, the printhead assembly can be a page wide printhead assembly that is stationary and positioned to print across an entire width or substantially an entire width of the print media as it is fed past the printhead assembly. The printer can include any other suitable components to allow the printer to function properly, such as a power module, a processor, memory, a display, a printing fluid reservoir, a communications module, etc.

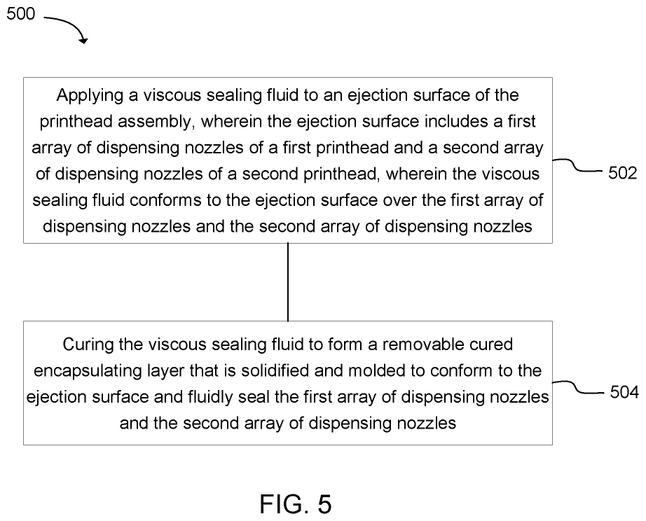

The present disclosure also describes a method of fluidly sealing dispensing nozzles of a printhead assembly. The method is represented in FIG. 5. For example, the method 500 of fluidly sealing dispensing nozzles of a printhead assembly can include applying 502 a viscous sealing fluid to an ejection surface of the printhead assembly, wherein the ejection surface includes a first array of dispensing nozzles of a first printhead and a second array of dispensing nozzles of a second printhead. The viscous sealing fluid can conform to the ejection surface over the first array of dispensing nozzles and the second array of dispensing nozzles. The method can also include curing 504 the viscous sealing fluid to form a removable cured encapsulating layer that is solidified and molded to conform to the ejection surface and fluidly seal the first array of dispensing nozzles and the second array of dispensing nozzles.

In further detail, a variety of viscous sealing fluids can be used. Generally, the viscous sealing fluid can be a fluid with sufficient flowability to fill gaps caused by printhead to printhead misalignment or offset, that has a viscosity high enough to not readily infiltrate the dispensing nozzles, and that is curable to transform from a gel or viscous fluid form to a more solidified form. In the solidified form, the cured encapsulation layer can have sufficiently high adhesive force to shield or cap individual dispensing nozzles. Thus, a viscous sealing fluid can be applied to the ejection surface that is sufficiently viscous to not penetrate into the dispensing nozzles but that is sufficiently fluid to conform to the ejection surface and form a fluid seal against the dispensing nozzles. Where the sealing fluid does not have an adequate viscosity, it can drain into the dispensing nozzles prior to curing and plug the dispensing nozzles. Conversely, where the sealing fluid is too viscous, it may not adequately conform to the ejection surface to form a fluid seal with the dispensing nozzles. As such, the viscosity of the sealing fluid can be a factor in preparing a suitable removable cured encapsulation layer. In some examples, the viscous sealing fluid can have a viscosity of from about 25,000 centipoise (cP) to about 150,000 cP. In other examples, the viscous sealing fluid can have a viscosity of from about 70,000 cP to about 150,000 cP.

Once the viscous sealing fluid is applied to the ejection surface of the printhead assembly, the viscous sealing fluid can be cured to form a removable cured encapsulating layer that is solidified and molded to conform to the ejection surface. The viscous sealing fluid can be cured in a number of ways. In some examples, the viscous sealing fluid can be electromagnetically cured, such as via UV irradiation, IR irradiation, or the like. In some additional examples, the viscous sealing fluid can be cured thermally. For example, in some cases, the viscous sealing fluid can include a thermoplastic polymer that can harden upon exposure to a predetermined temperature. In still additional examples, the viscous sealing fluid can be chemically cured via a curing or crosslinking agent.

In some examples, curing can be performed relatively soon after application of the viscous sealing fluid. The timeframe within which the viscous sealing fluid may be cured can depend on a number of factors, such as the viscosity of the viscous sealing fluid, the compositional components, the type of curing used, etc. For example, in some cases, curing can be performed within about 5 minutes from the time of application of the viscous storage fluid. In further detail, curing can be performed within about 2 minutes, 1 minute, or 30 seconds from the time of application of the viscous storage fluid, e.g., from about 5 seconds to about 5 minutes, about 15 seconds to about 5 minutes, about 30 seconds to about 5 minutes, about 1 minute to about 5 minutes, from about 5 seconds to about 2 minutes, from about 5 seconds to about 1 minute, from about 5 seconds to about 30 seconds, etc.

In some further examples, curing can occur contemporaneously with application of the viscous sealing fluid. For example, as the sealing fluid is applied to the ejection surface, an electromagnetic radiation source, a heat source, or the like can follow closely behind the coating apparatus to contemporaneously cure the viscous coating fluid as it is coated onto the ejection surface of the printhead assembly.

The viscous sealing fluid can have a variety of compositions. In some examples, the viscous sealing fluid can be a hot melt material. For example, the viscous sealing fluid can include a hot melt material based on cellulose acetate butyrate, a thermoplastic rubber, other suitable hot melt material, the like, or a combination thereof. In other examples, the viscous sealing fluid can include an electromagnetically curable composition. For example, in some cases, the viscous sealing fluid can include a photoinitiator. In some further examples, the photoinitiator can be present in an amount of from about 0.5 wt % to about 10 wt %, or from about 1 wt % to about 5 wt % of the total amount of the viscous sealing fluid prior to curing. In some additional examples, the viscous sealing fluid can include a polyurethane acrylate oligomer, an acrylate oligomer, an isobornyl acrylate, an acrylate ester, the like, or a combination thereof. In some specific examples, the viscous sealing fluid can include from about 50 wt % to about 75 wt % of a polyurethane acrylate oligomer, from about 5 wt % to about 20 wt % of an acrylate oligomer, from about 15 wt % to about 25 wt % of an isobornyl acrylate, from about 1 wt % to about 5 wt % of an acrylate ester, or a combination thereof.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the printhead assemblies, the printers, and the methods of sealing dispensing nozzles of a printhead assembly, each of these discussions can be considered applicable to each of these examples, whether or not they are explicitly discussed in the context of that example. Thus, for example, in discussing details about the printhead assemblies per se, such discussion also refers to the printers and the methods of sealing dispensing nozzles of a printhead assembly described herein, and vice versa.

The following illustrates an example of the disclosure. However, it is to be understood that this example is merely illustrative of the application of the principles of the present disclosure. Numerous modifications and alternative compositions, methods, and systems may be devised by those skilled in the art without departing from the spirit and scope of the present disclosure. The appended claims are intended to cover such modifications and arrangements.

### EXAMPLE

This technology has been described with reference to certain examples, and those skilled in the art will appreciate that various modifications, changes, omissions, and substitutions can be made without departing from the spirit of the disclosure. It is intended, therefore, that the present disclosure be limited only by the scope of the following claims.

A variety of encapsulation materials were studied as potential candidates for forming a molded encapsulation cap on a printhead assembly to provide a fluid seal for individual dispensing nozzles of the printheads. Specifically, encapsulation materials were prepared with a hot melt material based on cellulose acetate butyrate, a hot melt material based on a thermo-plastic rubber, and a UV curable material having a formulation according to Table 1.

TABLE 1
UV Curable Material Composition

| Chemical Component | Weight Percent (wt %) |
|---|---|
| Polyurethane acrylate oligomer | 50-75 |
| Acrylate oligomer | 5-20 |
| Isobornyl acrylate | 15-25 |
| Acrylate esters | 1-5 |
| Photoinitiator | 1-5 |

Each of the recited materials was coated onto an ejection surface of comparative printhead assemblies and cured. The printhead assemblies were subsequently subjected to a variety of thermal soak and vibration studies. Initially, the comparative printhead assemblies were vibrated at 2.03 gsm for 30 minutes. The hot melt material based on the thermo-plastic rubber material failed the vibration study and air was able to penetrate the encapsulation material. The other two materials were resilient to the vibrational study and did not allow air to penetrate the encapsulation layer.

The comparative printhead assemblies that passed the initial vibration study were then temperature soaked at −40° C. for 12 hours and then vibrated at 2.03 gsm for 30 minutes. Both the UV curable material and the hot melt material based on cellulose acetate butyrate were again resilient to the temperature soak and subsequent vibration and no air was allowed to penetrate the encapsulation layer.

The comparative printhead assemblies were then temperature soaked at 60° C. for 12 hours. In this example, the hot melt material based on cellulose acetate butyrate failed the temperature soak at lateral edges of the encapsulation layer and air was able to penetrate at the edges of the layer. The UV cure material was resilient to this temperature soak as well and did not allow air to penetrate the encapsulation layer. However, to further test the hot melt material based on cellulose acetate butyrate, a printhead assembly was recoated with the hot melt material and again subjected to the 60° C. soak for 12 hours. In this case, the hot melt material also passed the heat soak and no air was allowed to penetrate the encapsulation layer. Only after the hot melt encapsulation layer was first subjected to the initial vibration study and −40° C. temperature soak for 12 hours did the hot melt material fail during the 60° C. soak for 12 hours. Thus, the hot melt material based on cellulose acetate butyrate was also quite resilient to both vibrational exposure and extreme temperature soaking.

What is claimed is:

1. A printhead assembly, comprising:
a first printhead including a first array of dispensing nozzles, wherein the first array of dispensing nozzles are positioned along an ejection surface of the printhead assembly;
a second printhead including a second array of dispensing nozzles, wherein the second array of dispensing nozzles are also positioned along the ejection surface of the printhead assembly; and
a removable cured encapsulating layer molded to conform to the ejection surface and fluidly seal the first array and the second array of dispensing nozzles.

2. The printhead assembly of claim 1, further comprising a first printing fluid in fluid communication with the first array of dispensing nozzles and a second printing fluid in fluid communication with the second array of dispensing nozzles, wherein the first printing fluid and the second printing fluid are sealed behind the removable cured encapsulating layer.

3. The printhead assembly of claim 1, wherein the removable cured encapsulating layer is a UV cured polymeric layer.

4. The printhead assembly of claim 1, wherein the removable cured encapsulating layer is cohesive and has an adhesive strength suitable to allow for peeling from the ejection surface as well as the first and second array of dispensing nozzles as a single piece.

5. The printhead assembly of claim 1, wherein the printhead assembly is a page wide printhead assembly, and wherein the page wide printhead assembly includes from three to twenty printheads individually associated with a respective array of dispensing nozzles.

6. The printhead assembly of claim 1, wherein the removable cured encapsulating layer further includes a support material associated therewith.

7. The printhead assembly of claim 6, wherein the support material is a mesh material that is partially or fully encapsulated within a cured polymer of the removable cured encapsulating layer.

8. A printer, comprising:
a printhead assembly, comprising:
a first printhead including a first array of dispensing nozzles in fluid communication with a first storage fluid, wherein the first array of dispensing nozzles are positioned along an ejection surface of the printhead assembly,
a second printhead including a second array of dispensing nozzles in fluid communication with a second storage fluid, wherein the second array of dispensing nozzles are also positioned along the ejection surface of the printhead assembly, and
a removable cured encapsulating layer molded to conform to the ejection surface and fluidly seal the first storage fluid within the first array of dispensing nozzles and the second storage fluid within the second array of dispensing nozzles; and
a removal device controlled by the printer to peel the removable cured encapsulating layer from the ejection surface, the first array of dispensing nozzles, and the second array of dispensing nozzles.

9. The printer of claim 8, further comprising a print media feeder to position and feed print media to a print area operably associated with the first printhead and the second printhead.

10. The printer of claim 8, wherein the printhead assembly is a page wide printhead assembly, and wherein the page wide printhead assembly includes from three to twenty printheads individually associated with a respective array of dispensing nozzles.

11. The printer of claim 8, wherein the first storage fluid is a first printing fluid and the second storage fluid is a second printing fluid.

12. A method of fluidly sealing dispensing nozzles of a printhead assembly, comprising:
applying a viscous sealing fluid to an ejection surface of the printhead assembly, wherein the ejection surface includes a first array of dispensing nozzles of a first printhead and a second array of dispensing nozzles of a second printhead, wherein the viscous sealing fluid conforms to the ejection surface over the first array of dispensing nozzles and the second array of dispensing nozzles; and
curing the viscous sealing fluid to form a removable cured encapsulating layer that is solidified and molded to conform to the ejection surface and fluidly seal the first array of dispensing nozzles and the second array of dispensing nozzles.

13. The method of claim 12, wherein the viscous sealing fluid has a viscosity of from about 25,000 centipoise (cP) to about 150,000 cP.

14. The method of claim 12, wherein the curing of the viscous sealing fluid to form a removable cured encapsulating layer further includes UV curing.

15. The method of claim 12, wherein curing occurs within about 5 minutes from a time of application of the viscous sealing fluid.
